(19) United States
(12) Patent Application Publication
(10) Pub. No.: US 2006/0266737 A1
(43) Pub. Date: Nov. 30, 2006

(54) Process for removal of metals and alloys from a substrate

(76) Inventors: Ronald J. Hanestad, Glenwood City, WI (US); Erik D. Olson, Shakopee, MN (US); Michael Fussy, Shakopee, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/440,670

(22) Filed: May 25, 2006

Related U.S. Application Data
(60) Provisional application No. 60/685,629, filed on May 27, 2005.

(51) Int. Cl. B44C 1/22

(52) U.S. Cl. 216/96

(57) ABSTRACT

A metal that can be dissolved in aqua regia or a metal alloy containing a metal that can be dissolved in aqua regia can be effectively removed from a substrate, and particularly a silicon wafer substrate by a method of application of a composition having a HCl (concentrated)/hydrogen peroxide (concentrated) volume ratio of about 1:1 to about 4:1 that is substantially free of added water. In another embodiment, a metal that can be dissolved in aqua regia or a metal alloy containing a metal that can be dissolved in aqua regia is removed from a substrate by a composition comprising HCl (concentrated)/hydrogen peroxide (concentrated)/water in a volume ratio of from about 2:0.5:4 to about 4:2:4. The composition, heated to a temperature of about 60° C. to about 100° C., is applied to a substrate having the metal or metal alloy thereon, which is preferably heated to a temperature of from about 50° C. to about 100° C. The metal or metal alloy preferably is platinum metal or a metal alloy comprising platinum metal, and the substrate is a silicon wafer substrate.

This application claims the benefit of U.S. Provisional Application Ser. No. 60/685,629 filed on May 27, 2005, entitled “PROCESS,” which application is incorporated herein by reference in its entirety.

### FIELD OF THE INVENTION

The present invention relates to methods for removal of metals and metal alloys that can be dissolved in aqua regia from substrates.

### BACKGROUND OF THE INVENTION

Advances in electronic technology cause integrated circuits to be formed on substrates such as silicon wafers with ever increasing packing density of active components. The formation of circuits is carried out by sequential application, processing, and selective removal of various components from the substrate. Various compositions have been developed for removal of specific classes of components from substrates in semiconductor wafer technologies. For example, a composition commonly denoted SC-1, which contains a mixture of NH₄OH (29 wt %)/H₂O₂ (30 wt %)/Water at a volume ratio of about 1:1:5, is typically used to remove particles and to reoxidize hydrophobic silicon surfaces. Similarly, a composition commonly denoted SC-2, which contains a mixture of HCl (37 wt %)/H₂O₂ (30 wt %)/Water at a volume ratio of about 1:1:5 (or at somewhat higher dilution ratios), which is typically used to remove metals. An additional composition, commonly called a Piranha composition, comprises H₂SO₄ (100 wt %)/H₂O₂ (30 wt %) at a volume ratio of from about 2:1 to 20:1, and is typically used to remove organic contamination or some metal layers. It has been found that the SC-2 formulation is ineffective for removal of platinum metal or a metal alloy comprising platinum metal under desired treatment conditions.

The use of a composition of HCl/H₂O₂ in a volume ratio of 1:3 has been suggested for stripping of platinum from a wafer using spray processing equipment. However, tests performed by the present applicant have shown that this composition is ineffective at stripping platinum.

Additional compositions have been developed for specialized cleaning processes. For example, U.S. Pat. No. 6,162,738 discloses a cleaning method wherein a stack including at least a layer of Ta₂O₅ and a layer of conductive material is provided that includes a conductive etch residue on at least portions thereof. The stack is exposed to a dilute aqueous composition comprising hydrochloric acid (HCl), hydrogen peroxide (H₂O₂), and deionized water (H₂O) to remove the conductive etch residue. The dilute aqueous composition may include a ratio of H₂O:H₂O₂:HCl in a range of about 100:1:0.5 to about 100:10:5.

In a specific process of wafer preparation, metals may be applied to silicon wafers, with the corresponding silicides being formed through, for example, an annealing process. After the silicide is formed, remaining metals and/or alloys are desirably selectively removed. One such material desirably used in this process is platinum or alloys thereof. A problem typically associated with the use of platinum is the lack of a practical selective removal process.

A method for forming a metal contact for a silicon sensor is disclosed in U.S. Pat. No. 6,107,170. In this method, platinum is deposited over a contact area and is then sintered to form platinum silicide. An aqua-regia (i.e. a mixture of hydrochloric acid and nitric acid) etch is then carried out to remove platinum everywhere except in the silicided contact areas. Subsequently, titanium/tungsten (TiW) is deposited over the platinum silicide, and gold is deposited over the TiW.

Similarly, U.S. Pat. No. 4,804,438 discloses a method of providing a pattern of conductive platinum silicide on a silicon substrate by depositing a layer of platinum under vacuum on a silicon substrate, which was previously provided with selected oxide regions to prevent oxygen from contaminating the deposited platinum layer. The substrate is then annealed for the first time in an atmosphere of 10⁻⁸ Torr or less to form a platinum silicide pattern in regions in which the deposited platinum directly contacts the silicon substrate. The substrate is then annealed for a second time in an atmosphere of oxygen to form a protective oxide layer over the silicide. Next the unreacted platinum deposited on the oxide regions is selectively removed by an aqua regia wet etch. The use of heated aqua regia leads to the formation of hazardous nitrogen dioxide (NO₂) which requires special exhaust treatment.

A method for forming low resistance contact areas using nickel and nickel-platinum suicides is describe by Kittle et al (Mat. Res. Soc. Symp. Proc. Vol. 765 © 2003 Materials Research Society, page D7.5.1). It is commonly known and practiced to selectively remove the unreacted nickel after formation of nickel silicide by the use of the Piranha solution described above. The attempted use of the Piranha solution to selectively remove the unreacted nickel-platinum alloy after formation of nickel-platinum silicide has been found to leave residues of unremoved platinum.

It is also commonly known and practiced to deposit a cap layer, such as a film of titanium nitride over the metal layer before the anneal step to form the metal silicide in order to prevent oxidation or nitridation of the metal layer. When a cap layer is used, it must also be removed as part of the selective metal removal step after silicide formation.

### SUMMARY OF THE INVENTION

It is desirable to provide a fast and efficient technique for removal of a metal that can be dissolved in aqua regia or a metal alloy containing a metal that can be dissolved in aqua regia from substrate surfaces using chemicals that are readily available and more environmentally friendly than heated nitric acid. Additionally, it is desirable to provide a method for removal of such materials using conventional processing equipment, and preferably spray processing equipment. In an embodiment of the present invention, the metal or metal alloy removing process is carried out without the use of nitric acid.

It has surprisingly been found that a metal that can be dissolved in aqua regia or a metal alloy containing a metal that can be dissolved in aqua regia can be effectively removed from a substrate, and particularly a silicon wafer substrate, without using aqua regia in the process. In an embodiment of the present invention, the metal that can be dissolved in aqua regia (either as a metal alone or as a metal in the alloy) is selected from the group consisting of gold, silver, platinum, palladium, rhodium and osmium. In a preferred embodiment, the metal that can be dissolved in aqua regia is platinum. In another preferred embodiment, the material to be removed from the substrate is platinum metal or a platinum alloy. In another preferred embodiment, the material to be removed from the substrate is a platinum/nickel alloy, most preferably a 5% platinum/95% nickel alloy.

The present invention provides as one embodiment a method for removal of metal or metal alloy that comprises use of a relatively concentrated HCl/H₂O₂ composition that is substantially free of added water. More specifically, a method is provided comprising the steps wherein concentrated HCl is first heated to a temperature of from about 40° C. to about 100° C. For purposes of the present invention, concentrated HCl is defined as an aqueous hydrochloric acid solution having a concentration of greater than about 30 wt %, and more preferably greater than about 35 wt %. Concentrated HCl solutions are typically available in standard reagent grade solutions at about 37 wt %, and these solutions are particularly preferred for use in the present invention due to ease of supply, consistency in acid concentration, and low quantity of added water. High concentration H₂O₂ is then mixed with the heated HCl. For purposes of the present invention, concentrated H₂O₂ is defined as an aqueous hydrogen peroxide solution having a concentration of greater than about 30 wt %. Concentrated H₂O₂ solutions are typically available in standard reagent grade solutions at about 30, 35, 50 and 70 wt %. Higher concentrations raise special safety and handling considerations, while lower concentrations introduce a less than desirable amount of water in the system of the present process. Standard reagent solutions having a peroxide concentration of about 30 wt % are particularly preferred for use in the present invention due to ease of supply, consistency in peroxide concentration, relative ease of handling requirements, and low quantity of added water.

The mixture of HCl (37 wt %) and H₂O₂ (30 wt %) forms a composition having a HCl/H₂O₂ volume ratio of about 1:1 (corresponding to final solution concentrations of about 19.0 wt % HCl and about 14.6 wt % H₂O₂) to about 4:1 (corresponding to final solution concentrations of about 29.9 wt % HCl and about 5.7 wt % H₂O₂). This composition is substantially free of added water (i.e. substantially no water is separately added to the composition, so that the composition contains substantially only the water that is associated with the concentrated HCl and H₂O₂). The combination of these components leads to an exothermic reaction. The HCl/H₂O₂ composition is maintained, heated, or allowed to heat to a temperature after mixing of from about 50° C. to about 100° C. The substrate having the metal or a metal alloy thereon preferably is heated to a temperature of from about 50° C. to about 100° C. The heated HCl/H₂O₂ composition is then exposed to the substrate to remove the metal or the metal alloy. Preferably, the substrate has a metal alloy comprising platinum metal thereon.

The method for removal of metal or metal alloy that comprises use of a relatively concentrated HCl/H₂O₂ composition that is substantially free of added water can be described in another way, by stating the amounts of components as a function of weight percent of ingredients. Thus, in an embodiment of the present invention, a method of removing the metal or metal alloy from a substrate is provided that comprises heating an HCl composition to a temperature of from about 40° C. to about 100° C. A hydrogen peroxide composition is mixed with the heated HCl composition to form a composition having an HCl concentration of from about 19 wt % to about 30 wt %, and a hydrogen peroxide concentration of from about 5 wt % to about 14 wt %. The HCl/H₂O₂ composition is maintained, heated, or allowed to heat to a temperature after mixing of from about 50° C. to about 100° C. The substrate is preferably heated to a temperature of from about 50° C. to about 100° C. This HCl/H₂O₂ composition is exposed to a substrate having the metal or a metal alloy thereon. Preferably, the substrate has a metal alloy comprising platinum metal thereon.

The present invention provides as another embodiment a method for removal of metal or metal alloy that comprises use of a relatively dilute HCl/H₂O₂/water composition. Thus, in another embodiment of the present invention, a method is provided wherein a metal that can be dissolved in aqua regia or a metal alloy containing a metal that can be dissolved in aqua regia is removed from a substrate by first providing a composition comprising HCl/H₂O₂/water (the HCl and H₂O₂ being provided in concentrated form, as discussed above) in a volume ratio of from about 2:0.5:4 (corresponding to final solution concentrations of about 12.6 wt % HCl and about 2.4 wt % H₂O₂) to about 4:2:4 (corresponding to final solution concentrations of about 16.0 wt % HCl and about 6.1 wt % H₂O₂). This composition is heated to a temperature from about 60° C. to about 100° C., and the substrate is preferably heated to a temperature of from about 50° C. to about 100° C. The composition is then exposed to the substrate having the metal or metal alloy thereon, to remove the metal or metal alloy.

The method for removal of metal or metal alloy that comprises use of a relatively dilute HCl/H₂O₂/water composition can be described in another way, by stating the amounts of components as a function of weight percent of ingredients. Thus, a method of removing a metal that can be dissolved in aqua regia or a metal alloy containing a metal that can be dissolved in aqua regia from a substrate is provided, wherein a composition comprising HCl/H₂O₂/water having an HCl concentration of from about 12 wt % to about 16 wt %, and a hydrogen peroxide concentration of from about 2 wt % to about 6.5 wt % is provided. This HCl/H₂O₂/water composition is heated to a temperature of from about 60° C. to about 100° C., and the substrate is preferably heated to a temperature of from about 50° C. to about 100° C. The HCl/H₂O₂/water composition is then exposed to a substrate having the metal or metal alloy thereon to remove the metal or metal alloy.

The method involving removal of the metal or metal alloy by a dilute composition of HCl and H₂O₂ as described above is particularly useful and surprisingly effective when the metal alloy is an alloy of platinum metal. Such dilute compositions have been found to be relatively less effective in removing platinum metal alone, but very effective in removal of alloys comprising platinum metal. In a particularly preferred embodiment, the method using a dilute composition of HCl and H₂O₂ as described above is particularly effective for removal of a platinum/nickel alloy.

In a preferred embodiment applicable in all of the above aspects of the present invention, the substrate having metal or a metal alloy additionally comprises a cap layer to prevent oxidation or nitridation of the metal or metal alloy layer. Most preferably, the cap layer comprises titanium nitride. Preferred methods of this embodiment comprise a step to remove the cap layer (such as by treatment with a HCl (37 wt %)/H₂O₂ (30 wt %) mixture in a volume ratio of from about 1:1), followed by the metal or metal alloy removal steps as described herein.

In another preferred embodiment applicable in all of the above aspects of the present invention, the method additionally comprises exposing the substrate having a metal or metal alloy thereon to a composition comprising H₂SO₄ (100 wt %)/H₂O₂ (30 wt %) at a volume ratio of from about 2:1 to about 20:1 prior to exposing the substrate to the HCl/H₂O₂ or the HCl/H₂O₂/water compositions described above.

The recitations of volume and weight percentages and ratios provided herein are based on aqueous solvent systems. In the event that the compositions utilize a mixed solvent system or non-aqueous solvent system, the corresponding volume and weight percentages and ratios should be adjusted to provide the same effective molar ratio of active species.

### BRIEF DESCRIPTION OF THE DRAWINGS

FIG. 1 is a schematic representation of an apparatus for carrying out the process of the invention.

FIG. 2 is an SEM image of a treated wafer segment.

FIG. 3 is an SEM image of a treated wafer segment.

FIG. 4 is an SEM image of a treated wafer segment.

FIG. 5 is an SEM image of a treated wafer segment.

FIG. 6 is an SEM image of a treated wafer segment.

FIG. 7 is an SEM image of a treated wafer segment.

FIG. 8 is an SEM image of a treated wafer segment.

FIG. 9 is an SEM image of a treated wafer segment.

FIG. 10 is an SEM image of a treated wafer segment.

### DETAILED DESCRIPTION

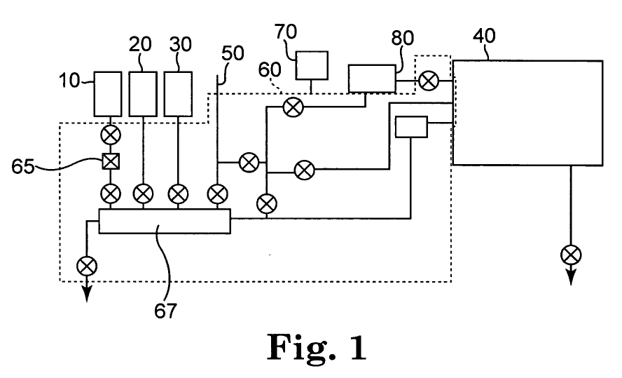

Preferred aspects of the present invention will now be described by reference to the drawings. The methods are preferably carried out using spray processing technology as illustrated in FIG. 1. Thus, the method can be carried out in a spray processing apparatus comprising:

a spray chamber (40);

a plurality of chemical supply reservoirs (10, 20, 30) including a first reservoir (10) containing therein a concentrated hydrochloric acid composition (preferred hydrochloric acid reagents are conventional 37 wt % HCl reagents) and a second reservoir (20) containing therein a concentrated peroxide composition (preferred peroxide reagents are conventional 30 wt % peroxide reagents);

a water source (50);

a controllable conduit system (60) for providing a spray of chemicals from said reservoirs or water or mixtures thereof as a spray on a substrate in the spray chamber, the conduit system including piping, spray nozzles in the chamber, a system of controllable valves and associated sensors to ascertain flow rate, an IR heater (65) and a mix manifold (67); and

a programmable controller (70) for the conduit system having a program entered into the controller, and communicating to the conduit system valves and sensors, whereby a specific sequence of sprays of water or chemical or mixtures thereof are provided to the spray chamber, the program being configured in a first embodiment to provide a mix and spray sequence for removal of metal or metal alloy that comprises use of a relatively concentrated HCl/H₂O₂ composition that is substantially free of added water. An exemplary program of this embodiment includes a mix and spray sequence that comprises:

a) Heating 37 wt % HCl to a temperature of from about 40° C. to about 100° C., and preferably to a temperature of from about 45° C. to about 55° C., using IR heater (65).

b) Mixing 30 wt % H₂O₂ with the heated HCl in mix manifold (67) to form a composition having a HCl (37 wt %)/H₂O₂ (30 wt %) volume ratio of about 1:1 (19.0 wt % HCl, 14.6 wt % H₂O₂) to about 4:1 (29.9 wt % HCl, 5.7 wt % H₂O₂), and more preferably a HCl (37 wt %)/H₂O₂ (30 wt %) volume ratio of from about 2.5:1 (26.9 wt % HCl, 8.2 wt % H₂O₂) to about 3.5:1 (29.1 wt % HCl, 6.4 wt % H₂O₂). This composition is substantially free of added water (i.e. water that is not present as an initial component of the concentrated reagents used). The addition takes place under conditions so that the mixed composition is at a temperature of from about 50° C. to about 100° C., and preferably at a temperature of from about 60° C. to about 80° C. It has been discovered that if the HCl and H₂O₂ are first mixed and then heated (e.g. by an IR heater), the mixture has a tendency to boil and to cause flow problems.

c) Spraying the HCl/H₂O₂ composition onto a substrate in spray chamber 40.

Spray chamber 40 preferably is provided with a temperature control apparatus so that the substrate can be preheated to a temperature of from about 50° C. to about 100° C., and preferably at a temperature of from about 60° C. to about 80° C. In a particularly preferred embodiment, the substrate is at about the same or higher temperature than the HCl/H₂O₂ composition being applied thereto. It has been found that the effectiveness of the removal of the metal or the metal alloy is substantially enhanced by first pre-heating the substrate prior to application of the HCl/H₂O₂ composition. In one aspect of the present invention, the substrate is raised in temperature by first dispensing a heated liquid, preferably hot water, onto the substrate to raise the temperature of the substrate to the desired temperature. Optionally, the heated liquid can be co-dispensed onto the substrate with the HCl/H₂O₂ composition during an initial time period of the substrate treatment process. After the initial co-dispensing, the substrate is treated with the HCl/H₂O₂ composition without dilution by terminating the dispensing of the heated liquid or by redirecting the flow of the heated liquid within the chamber (such as on a turntable or the floor or wall of the treatment chamber), thereby causing a heated mist to be formed that provides heat to the substrate. Alternatively, vaporized liquid or steam may be introduced to the chamber to raise the temperature of the substrate to the desired temperature with little or no dilution of the HCl/H₂O₂ composition as applied to the substrate.

In an embodiment of the present invention, water is sprayed onto the substrate for a time sufficient to achieve the desired temperature. After this temperature is achieved, the application of water is substantially ceased and the HCl/H₂O₂ composition is then dispensed onto the substrate for a desired period of time. Subsequent cycles of water heating and HCl/H₂O₂ composition dispensing are contemplated if desired to maintain the desired temperature within tolerances as may be assigned or determined. Thus, a series of treatment cycles is contemplated in this embodiment, which can be carried out in a manner similar to that disclosed in U.S. Pat. No. 5,861,064. Both overlapping and sequential application of water and HCl/H₂O₂ compositions on the substrate are contemplated. As a particular example, the substrate can be treated with a spray application of HCl/H₂O₂ composition for 60 seconds, followed by application of hot water for 30 seconds, followed again by a spray application of HCl/H₂O₂ composition for 60 seconds, which in turn is again followed by application of hot water for 30 seconds. One, two, three or more such cycles are specifically contemplated. Variations of dispensing steps and cycles are contemplated and will now be apparent to the skilled artisan in view of the present disclosure.

Surprisingly, platinum and/or platinum-containing alloys in particular can be removed from semiconductor wafers using the above-described process at a strip rate of at least about 10 angstroms per minute, and preferably from about 100 to about 300 angstroms per minute.

It will be noted that for the recited process steps, the additional chemical supply reservoirs and water source are not needed. It is often desirable to incorporate such components in the system to provide a fully flexible system for carrying out one or more processing steps independently of or in combination with the methods as described herein. For example, a nitrogen source (80) is suitably also provided, and further reservoirs may be added, for instance containing NH₄OH solution to allow preparation of SC-1 solution.

An apparatus for use in the present method can be prepared by modifying a known programmable spray processing machine such as a centrifugal spray processor of the type commercially available from FSI International, Chaska, Minn., under one or more of the trade designations MERCURY® or ZETA®, by providing the chemical reservoirs thereof with the necessary solutions and by configuring the machine's controller with a program as indicated herein. It will be understood that other known batch spray and single wafer spray machines can similarly be modified to carry out the present invention.

In another exemplary embodiment of the present invention, it has been discovered that a unique mix ratio of process materials and process conditions comprising use of a relatively dilute HCl/H₂O₂/water composition will strip metals and metal alloys, and in particular platinum alloys, from a substrate. In a preferred embodiment of this method, the method can be carried out using spray processing technology as illustrated in FIG. 1 as discussed above, with the following changes. In this method, a specific sequence of sprays of water or chemical or mixtures thereof are provided to the spray chamber, the program being configured to provide a mix and spray sequence comprising:

a) Providing a composition comprising HCl (37 wt %)/H₂O₂ (30 wt %)/water in a volume ratio of from about 2:0.5:4 (12.6 wt % HCl, 2.4 wt % H₂O₂) to about 4:2:4 (16.0 wt % HCl, 6.1 wt % H₂O₂), and preferably of about 3:1:4. Preheating of any of the components is not required, although it is permissible to do so provided that the mixture is not preheated and mixed in a combination (as discussed above) in a manner to cause boiling and flow problems of components.

b) Heating the HCl/H₂O₂/water composition to a temperature from about 60° C. to about 100° C., and preferably to a temperature of from about 80° C. to about 95° C. This heating is preferably carried out in an IR heater (not shown) located at or downstream from mix manifold (67); and

c) Spraying the HCl/H₂O₂/water composition onto a substrate having a metal or metal alloy thereon in spray chamber 40.

In an alternative exemplary configuration of this embodiment, the program is configured to provide a mix and spray sequence comprising:

a) Providing a composition HCl (37 wt %) at room temperature (about 25° C.) and water at about 85° C. to about 99° C., and mixing in a volume ratio of about 1:1.

b) heating or maintaining the temperature of the HCl/water mixture at a temperature greater or equal to about 80° C.

c) adding H₂O₂ (30 wt %) to the HCl/water mixture to provide a HCl (37 wt %)/H₂O₂ (30 wt %)/water volume ratio of from about 2:0.5:4 (12.6 wt % HCl, 2.4 wt % H₂O₂) to about 4:2:4 (16.0 wt % HCl, 6.1 wt % H₂O₂), and preferably about 4:1:4.

d) Spraying the HCl/H₂O₂/water composition at a temperature of from about 70° C. to about 85° C. onto a substrate having a metal or metal alloy thereon in spray chamber 40.

It will be understood that the discussion appearing above regarding process conditions such as chamber and substrate temperature control features, dispensing steps and cycles applies to the above embodiment as well in a manner that will now be appreciated by the skilled artisan.

Surprisingly, platinum-containing alloys can be removed from semiconductor wafers using the above-described processes using a relatively dilute HCl/H₂O₂/water composition at a strip rate of at least about 10 angstroms per minute, and preferably from about 100 to about 300 angstroms per minute, even though the same process will not as effectively remove platinum metal from semiconductor wafers.

There are substantial benefits arising in particular from using a dilute solution to remove metal and metal alloys. Because a dilute solution is used, the total amount of chemical usage is reduced, finding benefit in both material cost and effluent management. Additionally, dilute chemistries provide distinct advantages in exhaust management issues, in particular due to reduced gaseous HCl exhaust. Dilute chemistries provide the potential of avoiding use of expensive scrubbers to reduce or eliminate release of HCl gas. Additionally, dilute chemistries provide superior selectivity of material removal due to the tailored etch characteristic of the specific chemistry relative to the material to be removed.

Additional process steps are specifically contemplated for use in conjunction with the relatively concentrated HCl/H₂O₂ composition process or the relatively dilute HCl/H₂O₂/water composition process. Treatment with additional compositions, such as ammonia/peroxide/water mixtures (including SC-1 or other mix ratios such as NH₄OH (29 wt %)/H₂O₂ (30 wt %)/Water at a volume ratio of about 1:2:42); sulfuric acid/peroxide mixtures (e.g. H₂SO₄ (100 wt %)/H₂O₂ (30 wt %) at a volume ratio of from about 2:1 to about 20:1); and alternative concentration HCl/H₂O₂ and HCl/H₂O₂/water compositions (e.g. HCl/H₂O₂ a volume ratio of about 1:1) are specifically contemplated.

Specific embodiments of contemplated process programs include first treatment of a substrate with a sulfuric acid/peroxide mixture, followed by treatment with the relatively concentrated HCl/H₂O₂ composition described herein. In another embodiment, a substrate is first treated with a sulfuric acid/peroxide mixture, followed by treatment with the relatively concentrated HCl/H₂O₂ composition, which in turn is followed by treatment with an ammonia/peroxide/water mixture. In an alternative embodiment, interaction of the relatively concentrated HCl/H₂O₂ composition with the ammonia/peroxide/water mixture and adverse degradation of, for example, components made from Teflon® materials in the tool is minimized by treatment between the relatively concentrated HCl/H₂O₂ composition and the ammonia/peroxide/water mixture by a sulfuric acid/peroxide mixture. In another alternative embodiment, a substrate is first treated with the relatively concentrated HCl/H₂O₂ composition, followed by treatment with a sulfuric acid/peroxide mixture. In yet another embodiment, a substrate is first treated with a sulfuric acid/peroxide mixture, followed by treatment with the relatively dilute HCl/H₂O₂/water composition. Sequential and/or alternating treatments of the relatively concentrated HCl/H₂O₂ composition and the relatively dilute HCl/H₂O₂/water composition are also contemplated.

In a particularly preferred embodiment applicable in treatments both with the concentrated HCl/H₂O₂ composition and the relatively dilute HCl/H₂O₂/water composition, the substrate having metal or a metal alloy additionally comprises a cap layer to prevent oxidation or nitridation of the metal or metal alloy layer. Most preferably, the cap layer comprises titanium nitride. This cap can be removed at an appropriate stage of a wafer treatment process by with cap removing solutions, such as a HCl (37 wt %)/H₂O₂ (30 wt %) mixture in a volume ratio of from about 1:1, or by a H₂SO₄ (100 wt %)/H₂O₂ (30 wt %) mixture at a volume ratio of from about 2:1 to about 20:1.

The compositions and processes for removing metal and metal alloys may readily be adapted for use in systems comprising a recirculated bath, such as the FSI MAGELLAN® System.

The principles of the present invention will now be described in connection with the following illustrative examples.

### EXAMPLE 1 (COMPARATIVE)

In this example a beaker test was run with the chemistry solution known as Aqua Regia. The test was performed by preparing a solution of HCl (37 wt %):HNO₃ (70 wt %) in a volume ratio of 3.5:1 (corresponding to final solution concentrations of 27.6 wt % HCl and 17.7 wt % HNO₃). A beaker containing this solution was placed in a hot water bath set at a temperature of 55° C. A piece of a silicon wafer with a thin film of Pt deposited on the surface was immersed in the solution for a total time of 11 minutes. At the end of the 11 minute immersion time, the solution temperature measured about 57° C. The Pt film was completely removed as evidenced by visual observation and also by comparing a measurement of surface resistivity before and after the 11 minute immersion. The results of the resistivity measurement are shown in Table 1, Example 1. Before immersion, the surface resistivity measured about 6 ohms/square. After immersion in this example, the surface resistivity measured about 231 ohms/square. A surface resistivity measurement of over 200 ohms/square is indicative of complete film removal in these examples.

### EXAMPLE 2 (COMPARATIVE)

In this example a beaker test was run with a solution of HCl and H₂O₂. The test was performed by preparing a solution of HCl (37 wt %):H₂O₂ (30 wt %) in a volume ratio of 1:3 (corresponding to final solution concentrations of 9.7 wt % HCl and 22.2 wt % H₂O₂). The solution was created by adding 25 ml of HCl (37 wt %) and 75 ml of H₂O₂ (30 wt %) to the beaker. Without placing the beaker on a hotplate, the temperature of the mixture was monitored. The temperature of the mixture increased to 26.4° C. after 3 minutes and remained stable. A piece of a silicon wafer with a thin film of Pt deposited on the surface was immersed in the solution 11 minutes after the solution was first mixed. The wafer piece was initially immersed for 34 minutes while the solution temperature remained at 26.4° C. No visible attack of the Pt film was observed during this initial 34-minute immersion. At this point the beaker, still containing the solution and the piece of silicon wafer was placed in a hot water bath set at a temperature of 39.5° C. 13.5 minutes after the beaker was placed in the hot water bath, the solution temperature reached 80.3° C. and was boiling rapidly even though the temperature of the water bath never exceeded 47° C. At this point, the beaker, still containing the solution and the piece of silicon wafer, was removed from the hot water bath and cold water was sprayed on the side of the beaker to lower the solution temperature. The boiling activity of the solution in the beaker appeared to increase before the solution started to cool, however a maximum temperature was not recorded. 5 minutes after the beaker was removed from the hot water bath, the solution temperature decreased to 68.9° C. The piece of silicon wafer remained immersed until the total immersion time reached 63.5 minutes. At this point there was still no visible removal of the Pt film. Resistivity measurements also confirmed that this test did not remove the Pt film. The results of the resistivity measurements are shown in Table 1, example 2.

### EXAMPLE 3 (COMPARATIVE)

In this example a test was run in a MERCURY Spray System with a solution of HCl and H₂O₂ and additional water. The test was performed by dispensing a solution of HCl (37 wt %):H₂O₂ (30 wt %):H₂O in a volume ratio of 1:1:6.7 (corresponding to final solution concentrations of 4.9 wt % HCl and 3.7 wt % H₂O₂). A piece of a silicon wafer with a thin film of Pt deposited on the surface was attached to a fixture inside of the spray system so that it was exposed to the chemical solution in a manner similar to a standard full silicon wafer. The sample was exposed to the solution for 15 minutes with a temperature range of 60° C. to 74° C. After the piece of silicon wafer was removed from the spray system there was no visible removal of the Pt film. Resistivity measurements also confirmed that there this test did not remove the Pt film. The results of the resistivity measurements are shown in Table 1, example 3.

TABLE 1
Resistivity Results for Comparative Examples 1 through 3

| Example | Pre R (ohms/sq) | Post R (ohms/sq) |
|---|---|---|
| 1 (Aqua Regia) | 6.05 | 231.55 |
| 2 (1:3 HCl:H₂O₂) | 6.05 | 6.17 |
| 3 (1:1:6.7 HCl:H₂O₂:H₂O) | 6.05 | 5.76 |

### EXAMPLE 4

In this example a beaker test was run with a solution of HCl and H₂O₂. The test was performed by preparing a solution of HCl (37 wt %):H₂O₂ (30 wt %) in a volume ratio of 3:1 (corresponding to final solution concentrations of 28.1 wt % HCl and 7.2 wt % H₂O₂) The solution was created by adding 75 ml of HCl (37 wt %) and 25 ml of H₂O₂ (30 wt %) to the beaker. In this example, it was decided to try a solution that was more concentrated in HCl. A piece of a silicon wafer with a thin film of Pt deposited on the surface and also a piece of silicon wafer with a thin film of Pt deposited on a silicon oxide film on the surface were immersed in the solution for 7 minutes. The temperature of the solution reached ˜70° C. without external heating. Visual inspection of the samples indicated that the Pt film had been completely removed from both samples.

### EXAMPLE 5

In this example a test was run in a MERCURY Spray System with a solution of HCl and H₂O₂. The test was performed by dispensing a solution of HCl (37 wt %):H₂O₂ (30 wt %) in a volume ratio of 3:1 (corresponding to final solution concentrations of 28.1 wt % HCl and 7.2 wt % H₂O₂). The solution was formed by continuously mixing a 795 ml/minute flow of HCl (37 wt %) with a 265 ml/minute flow of H₂O₂ (30 wt %). A piece of a silicon wafer with a thin film of Pt deposited on the surface and also a piece of silicon wafer with a thin film of Pt deposited on a silicon oxide film on the surface were attached to a fixture inside of the spray system so that they were exposed to the chemical solution in a manner similar to a standard full silicon wafer. As the solution was dispensed, the samples were rotated in the system at a spin speed of 100 rpm. The samples were exposed to the solution for 13.5 minutes with a temperature range of 33° C. to 36° C. After the pieces of silicon wafer were removed from the spray system there was visibly discernable removal of the Pt film from both samples. It appeared that the Pt film that was directly deposited on the silicon wafer was about 40% removed and the Pt film that was deposited on the silicon oxide film on the silicon wafer was about 80% removed.

### EXAMPLE 6

In this example a test was run in a MERCURY Spray System with a solution of HCl and H₂O₂. A full-size, 150-mm diameter silicon wafer with a thin film of Pt deposited on the surface was placed inside the spray system for this test. The test was performed by dispensing a solution of HCl (37 wt %):H₂O₂ (30 wt %) in a volume ratio of 3:1 (corresponding to final solution concentrations of 28.1 wt % HCl and 7.2 wt % H₂O₂). The solution was formed by continuously mixing a 795 ml/minute flow of HCl (37 wt %) with a 265 ml/minute flow of H₂O₂ (30 wt %). In the previous MERCURY Spray System Example 4, with a more dilute solution, the solution was mixed before passing through the IR heater. In the previous MERCURY Spray System Example 5, a 3:1 mix ratio precluded use of the IR heater as the temperature control probe was not able to operate due to the vigorous bubbling of the solution immediately after mixing. Therefore, in this example only the HCl flow stream was heated by the IR heater, at a setpoint of 50° C., and then the H₂O₂ flow stream was mixed with the heated HCl flow stream using the Post IR Chemical Manifold. The combined solution was then dispensed onto the wafer inside the spray system. The temperature of the solution inside the spray chamber was measured after it passed over the wafer surface by use of a temperature probed mounted on the sidewall of the process chamber. During this test, the chemical solution was dispensed for 11 minutes. At the beginning of the 11-minute dispense time, it takes about 30 seconds for chemical to fill the IR heater and for the mixed solution with HCl and H₂O₂ to be dispensed into the chamber and onto the wafer. The temperature probe mounted on the chamber sidewall measured 38° C. at the beginning and increased to 49.9° C. at the end of the 11 minute dispense time. Visual inspection of the wafer after processing indicated that about 99% of the Pt film had been removed with only a few small spots of Pt remaining on the outer 5 mm edge of the wafer. Surface resistivity measurements also indicated complete removal of the Pt film. The results of the resistivity measurements are shown in Table 2, example 6.

### EXAMPLE 7

In this example a test was run in a MERCURY Spray System with a solution of HCl and H₂O₂. A full-size, 150-mm diameter silicon wafer with a thin film of Pt deposited on the surface was placed inside the spray system for this test. The conditions were the same as Example 6, except for the following changes: The IR heater temperature was set to 55° C. and prior to dispensing the mixed solution, hot water only was dispensed for 5 minutes to bring the temperature of the wafer and chamber to about 80° C. as measured by the sidewall temperature probe. In addition, during the 10 minute, 45 second chemical dispense time, hot water was co-dispensed with the mixed solution for the initial 45 seconds and then for 30 seconds intervals after every 2 minutes of mixed solution dispense without hot water. During the initial 45 seconds, about 30 seconds are required for the solution to fill the IR heater before chemical starts to dispense into the chamber and onto the wafer. During the 2-minute periods where only mixed solution was dispensed, the sidewall temperature probe measurement would fall to about 68° C. During the 30-second periods with hot water co-dispense, the sidewall temperature probe measurement would increase back to about 80° C. Visual inspection of the wafer after processing indicated that all of the Pt film had been removed except for a few very small spots of Pt remaining on the extreme outer edge of the wafer. Surface resistivity measurements also indicated complete removal of the Pt film. The results of the resistivity measurements are shown in Table 2, example 7.

### EXAMPLE 8

In this example a test was run in a MERCURY Spray System with a solution of HCl and H₂O₂. A full-size, 150-mm diameter silicon wafer with a thin film of Pt deposited on the surface was placed inside the spray system for this test. The conditions were the same as Example 7, except for the following changes: Mixed chemical solution was dispensed for a total time of 5 minutes, 15 seconds. As with example 7, hot water was co-dispensed with the mixed solution for the initial 45 seconds and then for an additional 30 seconds after 2 minutes of mixed solution dispense without hot water. Accordingly, the final 2 minutes of mixed solution dispense time was without additional hot water. Visual inspection of the wafer after processing looked very similar to example 7, even with the shortened dispense time, indicating that all of the Pt film had been removed except for a few very small spots of Pt remaining on the extreme outer edge of the wafer. Surface resistivity measurements also indicated complete removal of the Pt film. The results of the resistivity measurements are shown in Table 2, example 8.

### EXAMPLE 9

In this example a test was run in a MERCURY Spray System with a solution of HCl and H₂O₂. A full-size, 150-mm diameter silicon wafer with a thin film of Pt deposited on the surface was placed inside the spray system for this test. The conditions were the same as Example 8, except for the following changes: Mixed chemical solution was dispensed for a total time of 7 minutes, 45 seconds. As with example 8, hot water was co-dispensed with the mixed solution for the initial 45 seconds and then for 30 seconds intervals after every 2 minutes of mixed solution dispense without hot water. Accordingly, the final 2 minutes of mixed solution dispense time was without additional hot water. Visual inspection of the wafer after processing looked very similar to example 8, even with the shortened dispense time, indicating that all of the Pt film had been removed except for a few very small spots of Pt remaining on the extreme outer edge of the wafer. Surface resistivity measurements also indicated complete removal of the Pt film. The results of the resistivity measurements are shown in Table 2, example 9.

### EXAMPLE 10

In this example a test was run in a MERCURY Spray System with a solution of HCl and H₂O₂. A full-size, 150-mm diameter silicon wafer with a thin film of Pt deposited on the surface was placed inside the spray system for this test. The conditions were the same as Example 9, except for the following changes: Mixed chemical solution was dispensed for a total time of 6 minutes, 45 seconds. As with example 9, hot water was co-dispensed with the mixed solution for the initial 45 seconds. In this example, after the initial 45 seconds, hot water continued to be dispensed, but was diverted to the bottom of the process chamber and was dispensed onto the spinning turntable during the entire remaining 6 minutes, while mixed chemical solution was dispensed onto the wafer. Continuously dispensing hot water onto the turntable but not on the wafer caused the process chamber and wafer temperature to remain high, without causing dilution of the mixed chemical solution at the wafer surface. Alternatively, it would be possible to heat the wafer to the desired temperature by introducing steam into the chamber rather than hot water. Visual inspection of the wafer after processing indicated that all of the Pt film had been removed. Surface resistivity measurements also indicated complete removal of the Pt film. The results of the resistivity measurements are shown in Table 2, example 10.

### EXAMPLE 11

In this example a test was run in a MERCURY Spray System with a solution of HCl and H₂O₂. A full-size, 150-mm diameter silicon wafer with a thin film of Pt deposited on the surface was placed inside the spray system for this test. The conditions were the same as Example 7, except for the following changes: Mixed chemical solution was dispensed for a total time of 9 minutes, 15 seconds. As with example 7, hot water was co-dispensed with the mixed solution for the initial 45 seconds and then for 30 second intervals after every 2 minutes of mixed solution dispense without hot water. Accordingly, the final 2 minutes of mixed solution dispense time was without additional hot water. Visual inspection of the wafer after processing looked very similar to example 7, even with the shortened dispense time, indicating that all of the Pt film had been removed except for a few very small spots of Pt remaining on the extreme outer edge of the wafer. Surface resistivity measurements also indicated complete removal of the Pt film. The results of the resistivity measurements are shown in Table 2, example 11.

TABLE 2
Resistivity Results for Examples 6 through 11

| Example | Pre R (ohms/sq) | Post R (ohms/sq) |
|---|---|---|
| 6 | 6.29 | 243.44 |
| 7 | 6.03 | 209.37 |
| 8 | 6.03 | 234.28 |
| 9 | 6.21 | 223.31 |
| 10 | 6.05 | 236.76 |
| 11 | 6.32 | 225.78 |

### EXAMPLE 12

In this example, a patterned 300 mm diameter wafer was used which included regions of silicon oxide, single-crystalline silicon, and poly-crystalline silicon, all covered with a metal film consisting of a layer of Ni with 5% Pt with a cap layer of TiN. The wafer had been annealed (heat-treated) in order to form a metal silicide in the regions of single-crystalline silicon and poly-crystalline silicon. The purpose of the TiN layer is to protect the Ni—Pt layer from reaction with the ambient gases during the annealing process. It is the objective of this process to remove the TiN layer as well as any excess Ni and Pt that has not formed a metal silicide with the exposed silicon regions. This wafer was broken into small pieces for evaluation of Ni (Pt 5%) removal by the present platinum removal process. A Taguchi L9 Design Of Experiment was run in order to demonstrate the present metal removal process. In each test of the Taguchi L9 design the samples were first treated with a solution of sulfuric acid and hydrogen peroxide (also known as piranha or SPM) to remove the TiN capping layer. During this TiN removal step most of the excess Ni is also removed, leaving the platinum residues. This series of tests demonstrates the best conditions for removal of the platinum residues using the present process. The wafer samples were inspected by SEM in order to view the amount of remaining Pt residue, and the number of residues in a 5 micron square area, as determined by SEM inspection, were counted as indicated in Table 3.

The varied conditions of each test are shown in Table 3.

TABLE 3
Experimental conditions used in Example 12.

| | | | | final | final | | | |
|---|---|---|---|---|---|---|---|---|
| | 37 wt % | 30 wt % | | mix | mix | Chem. | | |
| | HCl | H₂O₂ | H₂O | HCl | H₂O₂ | dispense | | Residue |
| | flowrate | flowrate | flowrate | conc. | conc. | time | | spot |
| Trial # | (cc/min) | (cc/min) | (cc/min) | (wt %) | (wt %) | (min) | Temp (C.) | count |
| 1 | 200 | 200 | 1600 | 4.2 | 3.2 | 2 | 55 | 585 |
| 2 | 200 | 400 | 1400 | 4.2 | 6.4 | 3.5 | 70 | 92 |
| 3 | 200 | 600 | 1200 | 4.1 | 9.5 | 5 | 85 | 116° |
| 4 | 400 | 200 | 1400 | 8.3 | 3.2 | 3.5 | 85 | 24 |
| 5 | 400 | 400 | 1200 | 8.2 | 6.3 | 5 | 55 | 121 |
| 6 | 400 | 600 | 1000 | 8.2 | 9.4 | 2 | 70 | 72 |
| 7 | 600 | 200 | 1200 | 12.3 | 3.1 | 5 | 70 | 0 |
| 8 | 600 | 400 | 1000 | 12.2 | 6.2 | 2 | 85 | 0 |
| 9 | 600 | 600 | 800 | 12.0 | 9.2 | 3.5 | 70 | 0 |

In addition to the chemical solution flowrates indicated in Table 3, water was also provided in the mix in an amount sufficient to provide a total flow rate of 2000 cc/min for all samples. The Temperature variable represented the IR heater setpoint. All flow streams were mixed and then passed through the IR heater before being dispensed onto the wafers.

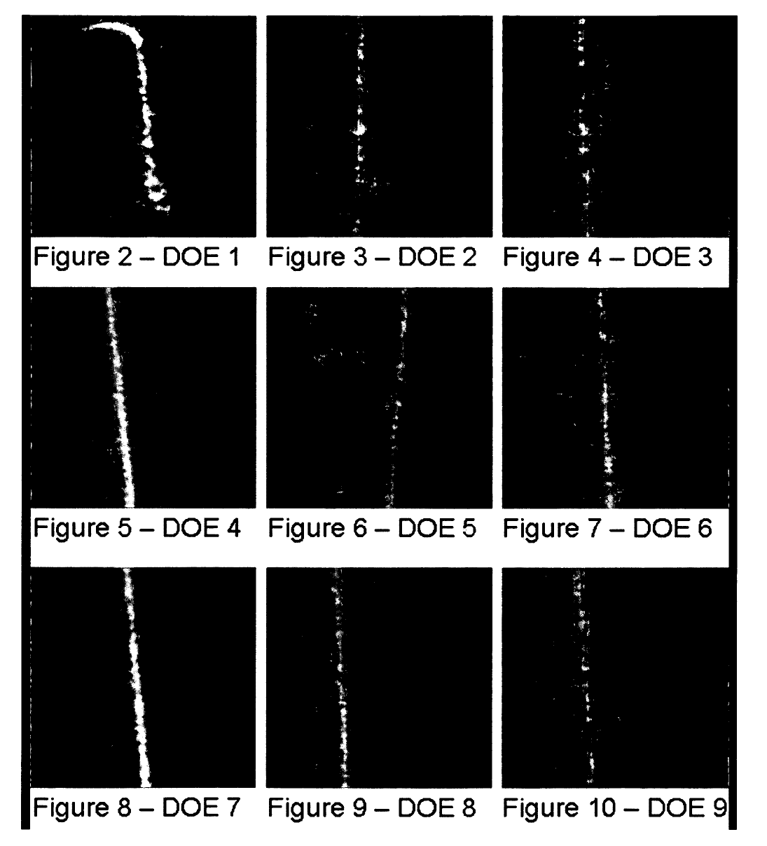

SEM images of a single-crystalline silicon region surrounded by a silicon oxide region are shown in FIGS. 2-10 for comparison. FIGS. 2-10 represent a portion of the wafer surface approximately 0.7 micron×0.7 micron in size.

All percentages and ratios used herein are weight percentages and volume ratios unless otherwise indicated. All publications, patents and patent documents cited are fully incorporated by reference herein, as though individually incorporated by reference. Numerous characteristics and advantages of the invention meant to be described by this document have been set forth in the foregoing description. It is to be understood, however, that while particular forms or embodiments of the invention have been illustrated, various modifications, including modifications to shape, and arrangement of parts, and the like, can be made without departing from the spirit and scope of the invention.

1. A method of removing a metal that can be dissolved in aqua regia or a metal alloy containing a metal that can be dissolved in aqua regia from a substrate, comprising
a) heating concentrated HCl to a temperature of from about 40° C. to about 100° C.;
b) mixing concentrated hydrogen peroxide with the heated concentrated HCl to form a composition having a HCl/H₂O₂ volume ratio of about 1:1 to about 4:1 and being substantially free of added water, so that the composition after addition is at a temperature of from about 50° C. to about 100° C.;
c) exposing the HCl/H₂O₂ composition to the substrate having the metal or metal alloy thereon.

2. A method of removing a metal that can be dissolved in aqua regia or a metal alloy containing a metal that can be dissolved in aqua regia from a substrate, comprising
a) heating an HCl composition to a temperature of from about 40° C. to about 100° C.;
b) adding a hydrogen peroxide composition to the heated HCl composition to form a composition having an HCl concentration of from about 19 wt % to about 30 wt %, and a hydrogen peroxide concentration of from about 5 wt % to about 14 wt %, so that the composition after addition is at a temperature of from about 50° C. to about 100° C.;
c) exposing the HCl/hydrogen peroxide composition to a substrate having the metal or metal alloy thereon.

3. The method of claim 1, wherein in step a) the HCl is heated to a temperature of from about 45° C. to about 55° C.

4. The method of claim 1, wherein in step b) the composition has a HCl/H₂O₂ ratio of about 2.5:1 to about 3.5:1.

5. The method of claim 1, wherein in step b) the composition after mixing of the hydrogen peroxide with the heated HCl is at a temperature of from about 60° C. to about 80° C.

6. A method of removing a metal that can be dissolved in aqua regia or a metal alloy containing a metal that can be dissolved in aqua regia from a substrate, comprising
a) providing a composition comprising HCl (concentrated)/H₂O₂ (concentrated)/water in a volume ratio of from about 2:0.5:4 to about 4:2:4;
b) heating the HCl/H₂O₂/water composition to a temperature of from about 60° C. to about 100° C.; and
c) exposing the HCl/H₂O₂/water composition to a substrate having the metal or metal alloy thereon to remove the metal or metal alloy.

7. A method of removing a metal that can be dissolved in aqua regia or a metal alloy containing a metal that can be dissolved in aqua regia from a substrate, comprising
a) providing a composition comprising HCl/H₂O₂/water having an HCl concentration of from about 12 wt % to about 16 wt %, and a hydrogen peroxide concentration of from about 2 wt % to about 9.5 wt %;
b) heating the HCl/hydrogen peroxide/water composition to a temperature of from about 60° C. to about 100° C.; and
c) exposing the HCl/hydrogen peroxide/water composition to a substrate having the metal or metal alloy thereon to remove the metal or metal alloy.

8. The method of claim 6, wherein in step b) the composition is heated to a temperature of from about 80° C. to about 95° C.

9. The method of claim 6, wherein the HCl/H₂O₂/water composition has a HCl/H₂O₂/water volume ratio of about 3:1:4.

10. The method of claim 1, wherein the metal that can be dissolved in aqua regia is selected from the group consisting of gold, silver, platinum, palladium, rhodium and osmium.

11. The method of claim 1, wherein the metal that can be dissolved in aqua regia is platinum.

12. The method of claim 1, wherein the substrate has platinum metal thereon.

13. The method of claim 1, wherein the substrate has a metal alloy comprising platinum metal thereon.

14. The method of claim 11, wherein the metal alloy is a platinum/nickel alloy.

15. The method of claim 1, wherein the substrate is at a temperature of from about 50° C. to about 100° C.

16. The method of claim 6, wherein the substrate having the metal or metal alloy thereon additionally comprises a cap layer to prevent oxidation or nitridation of the metal layer.

17. The method of claim 16, wherein the cap layer comprises titanium nitride.

18. The method of claim 1, further comprising treating the substrate with a sulfuric acid/peroxide mixture after to exposing the HCl/H₂O₂ composition to the substrate.

19. The method of claim 6, further comprising treating the substrate with a sulfuric acid/peroxide mixture prior to exposing the HCl/H₂O₂/water composition to the substrate.

20. The method of claim 6, wherein the metal or metal alloy is a platinum/nickel alloy, and the method further comprises exposing the substrate having a platinum/nickel alloy thereon to a composition comprising H₂SO₄ (100 wt %)/H₂O₂ (30 wt %) at a volume ratio of from about 2:1 to about 20:1 prior to exposing the HCl/H₂O₂/water composition to the substrate having a platinum/nickel alloy thereon.
